(19) United States
(12) Patent Application Publication
(10) Pub. No.: US 2026/0133017 A1
(43) Pub. Date: May 14, 2026

(54) LINEAR SHAPED CHARGE WITH INTEGRATED SHOCK WAVE AMPLIFICATION ELEMENT

(71) Applicant: MAXAMCORP INTERNATIONAL, S.L., MADRID (ES)

(72) Inventors: JOSÉ MANUEL BOTIJA GONZÁLEZ, GALDACANO (ES); FERNANDO MARÍA BEITIA GÓMEZ DE SEGURA, MADRID (ES)

(21) Appl. No.: 19/121,717

(22) PCT Filed: Oct. 16, 2023
(86) PCT No.: PCT/EP2023/078597

§ 371 Date: Apr. 16, 2025

(30) Foreign Application Priority Data
Oct. 17, 2022 (EP) 22382992.0

(51) Int. Cl. F42B 1/028; B26F 3/04; F42B 1/032

(52) U.S. Cl. CPC F42B 1/028; B26F 3/04; F42B 1/032

(57) ABSTRACT

The present invention relates to the field of explosives for use in demolition in public works. More specifically, it relates to an improved linear shaped charge that allows cutting a target material such as thick blocks (e.g. metal blocks) efficiently in the total length of the charge. In addition, the present invention also relates to a linear cutting charge system for cutting said target material and a method for cutting a target material by means of said linear shaped charge and system thereof.

### FIELD OF THE INVENTION

The present invention relates to the field of explosives for use in demolition in public works. More specifically, it relates to an improved linear shaped charge that allows cutting a target material such as thick blocks (e.g. metal blocks) efficiently in the total length of the charge. In addition, the present invention also relates to a linear cutting charge system for cutting said target material and a method for cutting a target material by means of said linear shaped charge and system thereof.

### BACKGROUND OF THE INVENTION

Shaped charges are explosive charges shaped to focus the effect of an explosive's energy. Different types of shaped charges are used for various purposes including both military and civil applications.

Shaped charges used in defense normally focus the energy released by the detonation at one point. The military industry uses these charges in projectiles and missiles for armor piercing. These shaped charges are commonly cylinders of explosive with a conical cavity or hollow at one end and an initiation system at the opposite end. The hollow cavity is lined with a thin layer of metal, plastic, ceramic, or similar materials (element known as liner), and the liner forms a jet once the explosive charge is detonated and drills the target material.

The shaped charges with one dimension significantly larger than the other are called linear shaped charges (LSC), which are also known as linear cutting charges (LCC).

LCCs use a liner having a cross section in the shape of an inverted V (dihedral shape), instead of a cone, and the explosive charge is shaped over the liner as a concave prism, which allows the jet to be focused downwardly along the longitudinal axis, producing a linear cut in the material on which it is projected. Linear cutting charges are applied in the dismantling of industrial facilities such as power plants, steel mills, chemical plants, as well as bridges or heavy mining machinery.

The performances of the LCCs are defined by the maximum thickness of the material that they can cut and depend on two mechanisms. In the first place, the penetration of the jet into the material to be cut exerts a pressure significantly higher than the compressive strength of the material being deformed plastically. The second mechanism is caused by the impact of the shock wave that fractures the material after the penetration of the jet. The sum of the two mechanisms results in the thickness of material being sheared by the linear shear load.

Among the factors that affect performance are the material and shape of the liner, the type, quantity and confinement of the explosive, the distance between the liner and the material to be cut (also called stand-off distance), as well as the type and initiation zone.

One of the problems found in current LCCs is that the penetration capacity of the formed jet is not constant throughout the entire length of the charge and, therefore, the resulting cut is not homogeneous in the material to be cut. To solve this problem, charges of greater length than the material to be cut are used.

The lower efficiency can be due to different factors, among them the lack of homogeneity of the explosive in the charge, the asymmetry in relation to the longitudinal central axis and/or improper initiation.

The way the cutting charges are initiated often depends on the type of casing or shell in which the explosive is housed. In those cases in which the explosive is housed in a metal shell, the only initiation option is the insertion of one or more detonators or boosters at one end of the cutting charge. In other cases, the detonator, booster or detonating cord can be placed in the upper area of the charge, originating separations or interfaces between the initiation system and the explosive of the charge, which causes a lack of homogeneity in the cut.

The introduction of the initiation system inside the explosive charge, regardless of its position, also reduces the cutting capacity of the charge. According to explosive initiation theories, depending on the initiation system and the explosive to be initiated, a minimum distance is required for the explosive before steady-state detonation can be achieved (“run distance”). When steady-state is not reached, part of the explosive and, therefore, of the cutting charge do not reach their maximum performance (Theories of Initiation Chapter 22, p 312. Explosives Engineering Paul W. Cooper Wiley-VCH 1996).

Taking into account the properties of the shock wave that leads to initiation, two conditions are required for initiation of detonation: the shock strength must be above a certain minimum value and the shock wave must last a minimum amount of time. Thus, shock waves with lower pressure, and that remain longer in the explosive to be initiated, can be more effective than those with higher pressure and that decrease rapidly (F. X. Jetté et al. Investigation of Lateral Effects on Shock Initiation of a Cylindrical Charge of Homogeneous Nitromethane, 18th Int. Colloquium on the Dynamics of Explosions and Reactive Systems, Seattle, WA, 2001. http://www.icders.org/ICDERS2001/abstracts/IC DERS2001-118.pdf).

The geometric characteristics of the explosive to be initiated also require certain dimensional requirements. Thus, small diameter charges need a greater shock pressure, because lateral expansion waves reach the center core of the explosive earlier in small diameters charges than in large ones, which has the effect of reducing shock duration and pressure to a greater extent in small charges (F. X. Jetté et al., above referenced). Therefore, initiation is a physical process resulting from complex interactions between shock waves, detonation and rarefaction that, depending on the intensity and relative times of the interactions, can give rise to the formation of desensitized zones or dead zones that do not lead to initiation (E. Ioannou et al. Multiphysics modeling of the initiating capability of detonators. II. Booster initiation, J. Appl. Phys. 129, 025903 (2021). https://aip.scitation.org/doi/10.1063/5.0031260).

In order to solve the above problems and improve the initiation of cutting charges, different initiation points or simultaneous linear initiation mechanism have been proposed (U.S. Pat. No. 10,641,588B2, Simultaneous linear initiation mechanism). In the latter case, these authors propose initiation through the use of different layers and channels in a complex way.

In other types of charges where the explosive is covered by a metal casing, the central initiation gives rise to a cutting profile where performance clearly decreases both in the area near the initiation and at each of the ends of the charge (Ortel, Matthew, “A modified initiation and cut profile study of the 10500 grain per foot linear shaped charge” (2014). Masters Theses. 7337. https:/scholarsmine.mst.edu/masters theses/7337).

Thus, there is still a need to develop linear cutting explosive charges that overcome the limitations of the above-mentioned systems and produce a highly effective and homogeneous linear cut throughout the entire cutting area.

### BRIEF DESCRIPTION OF THE INVENTION

The present invention provides a solution to the aforementioned problems by means of a linear cutting charge for cutting a target material according to claim 1, a linear cutting charge system according to claim 14 and a method for cutting a target material according to claim 15. The dependent claims define preferred embodiments of the invention.

In the present invention, the problems of inefficiency of the initiation systems described above are solved by providing a linear cutting charge with a shock wave amplification element comprising an explosive material, preferably small with respect to the total amount of explosive material, which is made of the same explosive material as the explosive charge and which is integrated in the explosive charge located on top of the inner surface of the liner, and whose function is to obtain a sufficient run distance to achieve a steady-state detonation in the explosive charge. The linear cutting explosive charge of the present invention may advantageously produce a 100% effective and homogeneous linear cut throughout the entire area of a target material. The shock wave amplification element, located on top of the explosive charge, provides an additional distance between the liner and the detonator, housed in said shock wave amplification element, and ensures that the run distance is sufficient for a stable regime of detonation before the explosive charge is reached previous to hitting the liner, and consequently maintaining optimal and homogeneous cutting through the entire area of the target material.

In a first inventive aspect, the present invention provides a linear cutting charge for cutting a target material, wherein the linear cutting charge comprises:
a liner having a concave shape, wherein the liner comprises an inner surface and an outer surface, and wherein the outer surface conforms a hollow cavity,
an explosive charge, having a longitudinal axis X-X′, located on top of the inner surface of the liner,
a shock wave amplification element located on top of the explosive charge wherein the shock wave amplification element comprises a hole configured for housing an external initiation means; and
a shell having a cavity, wherein the shell is configured for housing the liner, the explosive charge and the amplification element;
wherein the shock wave amplification element and the explosive charge are made of the same explosive material.

In some particular embodiments of the first inventive aspect, the liner is shaped, in a two dimension referential, as a concave prism, a concave inverted V or a concave inverted semi ellipse. Other concave shapes for the liner comprises hemispherical, trumpet, tulip or tapered conical shape.

The liner has an inner surface and an outer surface. The outer surface is the surface oriented towards the target material when the device is in operative conditions and the inner surface is the surface in direct contact with the explosive charge, oriented towards the opposite side of the outer surface.

One of the most important elements of the shaped charges is the cavity liner. The liner is a source of heavy molecules accelerated by detonation energy and focused on the target material. The shape and geometrical properties of the liner determine the properties of the formed cut and the application of the shaped charge. Linear shaped charges, as the one of the present invention, have a liner having a concave shape in cross section (dihedral shape in three dimensions) which extends in a substantially longitudinal direction. The concave shape of the liner enhances the concentration of forces generated by the detonation in one direction, creating an efficient cutting jet. It is to be understood that the concave shape defines an element that is curved inward with respect to the base of the shell, also called bottom side along the present document, which conform the hollow cavity.

The thickness of the liner can vary for instance from 0.1 mm to 5 mm depending on the specific needs such as about 0.1 mm, 0.5 mm, 1 mm, 1.5 mm, 2 mm, 2.5 mm, 3 mm, 3.5 mm, 4 mm, 4.5 mm and 5 mm. Nevertheless, thickness outside this range are also within the scope of the invention.

Typically, the liner is manufactured by bending a sheet of material, e.g. a metal sheet, by a machine or otherwise so as to acquire a concave shape with the desired angular opening. The angular opening of the liner that defines the hollow cavity is selected according to the effect which is sought. Typically, concave shape liners, more particularly V-shaped, show an angle of 60° to 120°, more particularly 75° to 105° or 85° to 95° and even more particularly about 90°.

In general, in the state of the art, the linear cutting charge is separated from the target material by means of spacers or lateral supports so as to reach an optimum stand-off distance, that is, the stand-off material is air. This makes difficult to place the LCC in the field. A key advantage of the present invention is that the distance between the base of the shell and the liner can match the distance at which the jet formed during the explosion of the LCC is focused. That is, in the present invention, the base of the shell may have a height equal to the optimum stand-off, which allows it to be placed directly on the target to be cut, guaranteeing adequate separation and facilitating the use. In some embodiments, this characteristic is feasible thanks to the selection of a low-density material for the shell with a low capacity to attenuate the metal jet of the liner produced by the explosion of the charge.

In particular embodiments, the stand-off distance is between 0.2 and 4 times the width of the liner, preferable 0.5 times the width of the liner. The width of the liner is to be understood as equal to the distance between both ends of the liner.

The shock wave amplification element can be configured to have dimensions and geometry that ensure a stable detonation of the total cutting charge, for which the axis of the shock wave amplification element is preferably placed on the upper part of the center of the charge and parallel to its plane of symmetry. Furthermore, the shock wave amplification element has a hole to house the external initiation means.

The shock wave amplification element can be for instance a cylinder, a parallelepiped or a truncated cone or any other geometric body, preferably with a width at its base equal to that of the top side of the explosive charge. To guarantee the minimum curvature of the shock wave front when reaching the explosive charge and its simultaneous initiation, the height of the amplification element is preferably greater than or equal to the width.

The ideal external initiation means position will normally be on top of the explosive charge and in the longitudinal center thereof. Other positions along the length of the charge are also possible, but preferably away from the ends by at least a distance equivalent to the width or diameter of the amplification element.

The shock wave amplification element and the explosive charge are made of the same explosive material. In other words, the shock wave amplification element and the explosive charge are integrated in the linear cutting charge of the invention as one unique element which show no separation or discontinuity between them.

In a particular embodiment, the shell comprises a low thermal conductivity material, preferably a material having a thermal conductivity below 10 W/mK.

Shells made of a material with a low thermal conductivity are preferred since it has been found that they allow avoiding discontinuities in the explosive when loading the shell with liquid explosives.

The optimum conductivity values of particular materials of the shell are generally less than 10 W/m K, with values less than 5 W/m K or 1 W/m K being more preferable.

In a particular embodiment, the shell comprises a low density material, preferably a material having a density below or equal to 1.1 g/cm³.

Shells made of a material with a low density are preferred since it has been found that offer little resistance to the jet produced from the liner collapse by the explosion of the charge.

The shell can be manufactured in principle in any dimensions depending on the specific use. In a particular embodiment, the width of the shell varies from 50 mm to 200 mm, e.g. from 75 mm to 175 mm. In a particular embodiment, the height of the shell varies from 50 mm to 200 mm, e.g. from 75 mm to 190 mm. In a particular embodiment, the length of the shell varies from 150 mm to 250 mm, e.g. from 175 mm to 225 mm. In these external dimensions, the length is always greater than the width. Exemplary embodiments of the invention are a 100 mm wide, 100 mm high and 200 mm long shell and a 160 mm wide, 180 mm high and 200 mm long shell.

In a more particular embodiment, the shell comprises a plastic or rubber material, preferably selected from the following list: ethylene vinyl acetate, nitrile rubber, silicone rubber, polychloroprene, polyvinyl chloride, polyimide, polyethylene, polypropylene, polystyrene or polyurethane or any combination thereof.

In a particular embodiment, the shell comprises a top side and a bottom side. The bottom side of the shell provides a stand-off distance between the liner and the target material.

As a skilled person widely knows, stand-off refers to the distance between the liner, at its nearest point to the target material to be cut, and the target material to be cut. Thus, the shell can be advantageously designed to be put directly on the target material to be cut so that the distance between the base of the shell and the liner corresponds to the optimum stand-off distance. That is, there is no need to include additional spacers or lateral supports between the LCC and the target.

In a particular embodiment, the liner is made of a metal, preferably selected from the following list: copper, iron, steel, aluminum, nickel, molybdenum, tantalum, uranium or tungsten or any combination thereof.

In the present invention, the liner with a dihedral shape on which the explosive charge is supported is preferably made of a high-density metal, preferably above or equal to 2.7 g/cm³. Among metals, the most commonly implemented is copper, and other materials can be used such as aluminum, steel, iron, nickel, molybdenum, tantalum, uranium or tungsten. According to particular embodiment, the liner material is aluminum or copper.

In a particular embodiment, the explosive of the shock wave amplification element and the explosive charge is a melted-cast explosive or a cast-cured explosive. More particularly, the melted-cast explosive comprises TNT or dinitroanisole, and even more particularly, the melted-cast explosive is selected from TNT or dinitroanisole and their mixtures with PETN, RDX or HMX.

In the present invention, the explosive charge is preferably liguid at the time of filling the shell of the linear cutting charge. Explosive charges that are liquid at the time of casting can be of two types, melted explosive or cured explosive.

In the case of melted explosives, they can be based on 2,4,6-Trinitrotolune (TNT) or 2,4-Dinitroanisole (DNAN) as a liquid component and their mixtures with other explosive materials such as pentaerythritol tetranitrate (PETN), cyclonite or cyclo-1,3,5-trimethylene-2,4,6-trinitramine (RDX), or octogen or cyclotetramethylene tetranitramine (HMX) and the like. Pentolite refers to a mixture of TNT and PETN, Composition B refers to a mixture of TNT and RDX and octol refers to a mixture of TNT and HMX.

In the case of cured explosives, as PBX (plastic bonded explosive) type, which consist of mixtures of a high explosive (e.g. PETN, RDX, or HMX) with a binder and a crosslinking agent.

In both melted and cured type explosives, the explosive charge is typically filled by casting and the final explosive achieves its mechanical characteristics either by solidification or by curing, for which good temperature control inside the shell is required.

In another particular embodiment, the explosive material of the shock wave amplification element and of the explosive material of the explosive charge is a cast-cured explosive selected from a plastic bonded explosive (PBX). More particularly, the explosive of the plastic bonded explosive may be made of a mixture of PETN, RDX or HMX with a binder and a cross-linking agent.

In a particular embodiment, the explosive charge covers the inner surface of the liner completely.

In a particular embodiment, the shock wave amplification element is placed on the longitudinal axis X-X′ of the explosive charge.

In a particular embodiment, the shock wave amplification element has the shape of a geometric body (e.g. a cylinder, a parallelepiped or a truncated cone) having a width, a length and a height, wherein the width at its bottom side, that is where the shock wave amplification element is in direct contact with the explosive charge, is equal to the width of the top side of the explosive charge.

In a second inventive aspect, the present invention provides a linear cutting charge system for cutting a target material comprising:
a linear cutting charge according to the first inventive aspect of the invention, and
at least one external initiation means.

In particular embodiments of the second inventive aspect, the linear cutting charge system comprises a plurality of external initiation means and the plurality of external initiation means are synchronized. Advantageously, the synchronization of external initiation means ensures a homogeneous and optimal cutting of the target material through the complete detonation of the explosive charge and shock wave amplification element located inside the linear cutting charge device.

In particular embodiments, the external initiation means is a detonator with booster.

In other particular embodiments, the linear cutting charge of the invention is initiated without booster and with one detonator.

In a third inventive aspect, the present invention provides a method for cutting a target material which comprises:
a) providing a linear cutting charge according to any of the embodiments of the first inventive aspect of the invention,
b) providing at least one external initiation means;
c) placing the linear cutting charge on the target material;
d) placing the at least one external initiation means in the hole of the shock wave amplification element; and
e) detonating the at least one external initiation means.

The explosive charge and the shock wave amplification element are materials which facilitates the filling steps of the volume of the linear cutting charge device of the invention dedicated to these elements.

In some embodiments, step d) is performed before step c).

In particular embodiments of the third inventive aspect of the invention, if more than one external initiation means is placed during step d) of the method above mentioned, the method further comprises the step of synchronizing the external initiation means before step e).

All the features described in this specification (including the claims, description and drawings) can be combined in any combination thereof, with the exception of combinations of such mutually exclusive features.

### BRIEF DESCRIPTION OF THE FIGURES

These and other characteristics and advantages of the invention will become clearly understood in view of the detailed description of the invention which becomes apparent from a preferred embodiment of the invention, given just as an example and not being limited thereto, with reference to the drawings.

FIG. 1A This figure shows a perspective view of a Linear Cutting Charge according to an embodiment of the invention.

FIG. 1B This figure shows a perspective cross-sectional view of the Linear Cutting Charge according to the embodiment of the invention of FIG. 1A.

FIG. 2 This figure shows a cross-sectional view of the Linear Cutting Charge according to the embodiment of the invention of FIGS. 1A and 1B

FIG. 3A-3C These figures show cross-sectional views of three positions relative to the external initiation means in the linear cutting charge. FIG. 3A is an embodiment of the invention and FIGS. 3B and 3C are embodiments which are not part of the invention.

### LIST OF NUMERICAL REFERENCES

1 Shell
1.1 Top side
1.2 Bottom side
1.3 Cavity
2 Liner
2.1 Inner surface
2.2 Outer surface
3 Explosive charge
4 Target material
5 Shock wave amplification element
5.1 Hole
6 External initiation means
10 Linear Cutting Charge
100 Linear Cutting Charge system

### DETAILED DESCRIPTION OF THE INVENTION

As will be appreciated by one skilled in the art, aspects of the present invention may be embodied as a linear cutting charge device, a linear cutting charge system or a method for cutting a target material.

The shaped charges can be generally divided into the following categories, according to their shape, focusing detonation energy and function:
conical shaped charges or perforators and
linear shaped charges or cutters.

The conical shaped charges or perforators are used for the perforation of a target material. The liner is of a concave shape, and detonation energy is focused on the single point.

The linear shaped charges, which is the subject of the present patent application, are used for cutting a target material. The liner is of a concave shape and detonation energy is focused along the longitudinal axis of the device. The performance of the conical shaped charge is defined by the depth of perforation in the material, while the performance of the linear shaped charge is defined by the maximum thickness of a material that can be cut.

Thus, a LCC has a liner consisting of, comprising or including a generally concave profile having a varying length. Explosive is then loaded on top of the liner and the explosive is encased within a suitable material that serves to protect the explosive and to confine or tamp it on detonation. The charge is detonated at some point in the explosive above the liner apex. The detonation projects the liner to form a continuous, knife-like (planar) jet. The jet cuts material in its path, to a depth which depends on the size of the charge and materials used in the charge. LCCs are used, for example, in the cutting of rolled steel joists and other structural targets, such as in the controlled demolition of buildings.

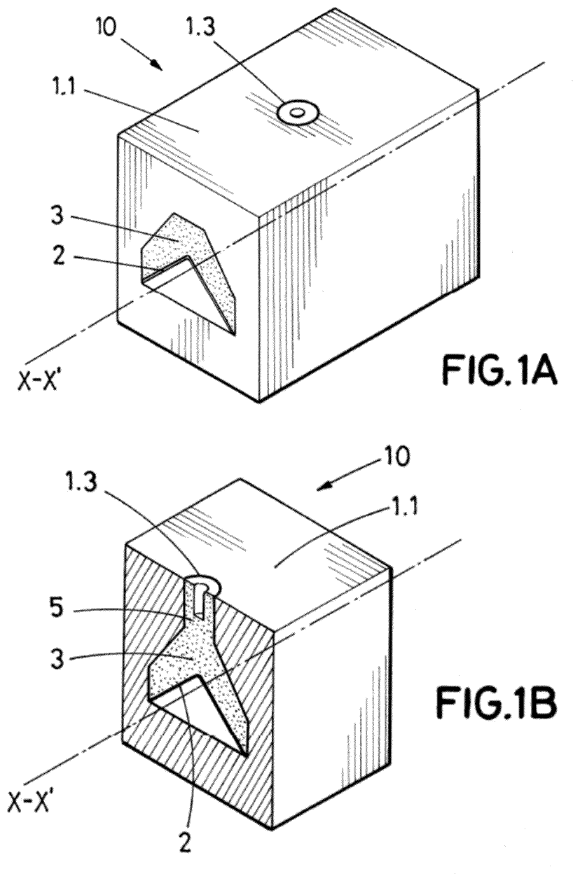

FIG. 1A shows a perspective view of a linear cutting charge (10) according to an embodiment of the invention. FIG. 1B shows a perspective cross-sectional view of the linear cutting charge (10) of FIG. 1A, taken at the central axis with respect to the top side (1.1) of the shell (1).

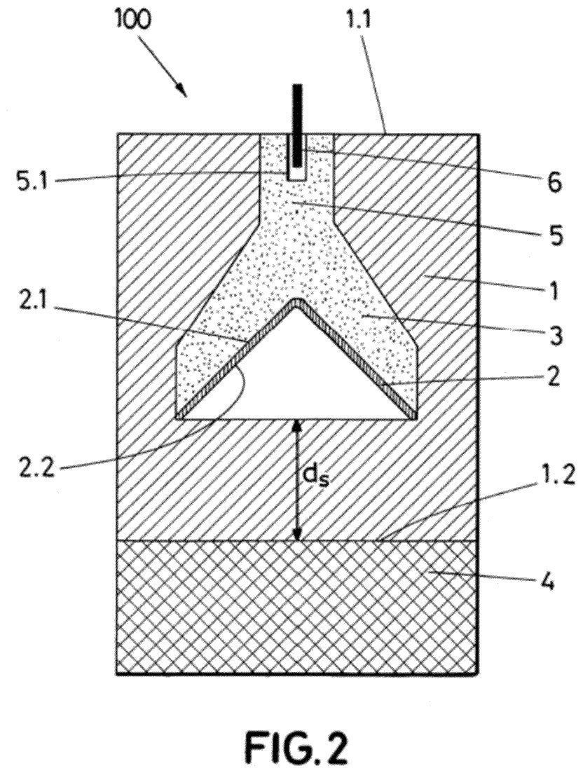

In FIG. 2, the different components of the linear cutting charge system (100) of the embodiment of FIGS. 1A and 1B are described. FIG. 2 shows a linear cutting charge system (100) comprising a shell (1). In this particular embodiment, the shell is hollow and has the shape of a parallelepiped. A liner (2) is placed inside the shell (1) and the liner (2) has a concave shape. More particularly in FIG. 2, the liner (2) presents an inverted V-shape. In three dimensions, it is understood that the liner (2) of the present embodiment of FIG. 2 presents a dihedral shape. In some other embodiments, not shown in the set of Figures, the liner (2) may be shaped as a concave prism, a concave inverted V or a concave inverted semi ellipse.

The liner (2) has an inner surface (2.1) and an outer surface (2.2). The linear cutting charge system (100) also comprises an explosive charge (3) which is located on top of the inner surface (2.1) of the liner (2). Also, a shock wave amplification element (5) is located on top of the explosive charge (3) and the shock wave amplification element (5) comprises a hole (5.1) configured for housing an external initiation means (6).

The shell (1) detailed in FIG. 2 is configured so that the distance between the liner (2) and the bottom side (1.2) of the shell (1) defines the stand-off distance dₛ which is the distance between the liner (2) of the linear cutting charge (10) and a target material (4) which is placed in direct contact with the bottom side (1.2) of the shell (1).

The top side (1.1) of the shell (1) has a cavity (1.3) (as shown in FIGS. 1A and 1B) where the shock wave amplification element (5) and the explosive charge (3) are introduced in order to fill the dedicated volume of the shell (1). The shell (1) is simultaneously filled with the shock wave amplification element (5), which is made of the same explosive material as the explosive charge (3) and is, therefore, an extension of said explosive charge (3). The shock wave amplification element (5) has a hole (5.1) intended to place an external initiation means (6), such as a detonator.

The shell (1) shows openings at each end of the linear cutting charge (10) as depicted in FIG. 1A. These openings make the ends of the liner (2) visible. In some other embodiments, the shock wave element (5) and the explosive charge (3) may be introduced by these openings in order to fill the dedicated volume of the shell (1) of the linear cutting charge (2).

In the present invention, the shell (1) preferably comprises a material having low thermal conductivity, preferably made of such a material having a thermal conductivity below 10 W/mK. Advantageously, this allows inter alia good control of the temperature of the explosive material inside the shell (1), both for the solidification and curing processes. Good temperature control is important to guarantee good mechanical properties of the explosive material as well as to avoid the formation of cracks, tensions, cavities and irregularities in the mass of the explosive material.

The optimum conductivity values of particular materials of the shell (1) are generally less than 10 W/m K, with values less than 5 W/m K or 1 W/m K being more preferable.

In some preferred embodiments, the shell (1) is made of a material having a density below or equal to 1.1 g/cm³. Examples of material suitable for the shell (1) include, but are not limited to, ethylene vinyl acetate (EVA), nitrile rubber (NBR), silicone, polychloroprene (Neoprene), polyvinyl chloride (PVC), polyimide, polyethylene (PE), polypropylene (PP), polystyrene (PS) and polyurethane (PU) foams and any combination of these polymers. Foam materials provides highly reduced densities and highly reduced conductivity with respect to non-foam material of the same material.

The table below gathers preferred densities and thermal conductivities values considered for Shell materials (Polymers and Foams) regarding particular embodiments of the device of the invention.

TABLE 1
Shell materials_Polymers &
Foams_Density & Thermal conductivity

| | | Thermal |
|---|---|---|
| | Density | conductivity |
| Shell materials | (g/cm³) | (W/m K) |
| High density polyethylene (HDPE) | 0.94-0.97 | 0.45-0.52 |
| Ethylene vinyl acetate polymer (EVA) | 0.92-0.93 | 0.43-0.50 |
| Low density polyethylene (LDPE) | 0.91-0.93 | 0.33 |
| Nitrile rubber (NBR) | 1.0 | 0.24 |
| Polypropylene (PP) | 0.86-0.95 | 0.11-0.22 |
| Silicone rubber | 1.1 | 0.14-0.2 |
| Polystyrene (PS) | 0.96-1.05 | 0.12-0.19 |
| Polychloroprene (Neoprene) | 1.23 | 0.19 |
| Polyvinyl chloride (PVC) | 1.2-1.4 | 0.14-0.19 |
| Polyimide | 1.42 | 0.12 |
| PVC foam | 0.04-0.33 | 0.03-0.06 |
| Silicone foam | 0.1 | 0.06 |
| PE foam | 0.02-0.15 | 0.04-0.06 |
| PS foam | 0.02 | 0.03-0.05 |
| PP foam | 0.04 | 0.05 |
| PU foam | 0.02-0.08 | 0.02-0.04 |
| EVA foam | 0.03 | 0.04 |
| NBR foam | 0.06 | 0.04 |
| Polychloroprene foam | 0.1-0.3 | 0.03 |
| Polyimide foam | 0.05 | 0.01 |

The shell (1) can be manufactured in principle in any dimensions depending on the specific use. In a particular embodiment, the width of the shell varies from 50 mm to 200 mm, e.g. from 75 mm to 175 mm. In a particular embodiment, the height of the shell varies from 50 mm to 200 mm, e.g. from 75 mm to 190 mm. In a particular embodiment, the length of the shell varies from 150 mm to 250 mm, e.g. from 175 mm to 225 mm. In these external dimensions, the length is always greater than the width. Exemplary embodiments of the invention are a 100 mm wide, 100 mm high and 200 mm long shell and a 160 mm wide, 180 mm high and 200 mm long shell.

One of the most important elements of the shaped charges is the cavity liner. The liner is a source of heavy molecules accelerated by detonation energy and focused on the target material. The shape and geometrical properties of the liner determine the properties of the formed cut and the application of the shaped charge. Linear shaped charges (10), as the one shown in FIG. 2, have a liner (2) having a concave shape, such as an inverted V in cross section as represented in FIG. 2, (conical or dihedral shape in three dimensions) which extends in a substantially longitudinal direction. The concave shape, particularly in FIG. 2 the inverted “V”-shape geometry of linear cutting charge (10), serves to concentrate the forces generated by the detonation in one direction, creating an efficient cutting jet.

As used herein, the term “longitudinal” refers to a direction parallel to the intended line of cut of the target material. The term “transversal” refers to a direction orthogonal to the longitudinal direction and orthogonal to the direction of propagation of the detonation.

Examples of materials suitable for the liner (2) of the present invention include, but are not limited to, metal, plastic and ceramic. Also it is possible to apply various metals as liner (2) material (e.g. bimetallic liners) as well as alloys (mixtures of more than one metal or mixtures of a metal with other non-metallic material).

The thickness of the liner (2) can vary for instance from 0.1 mm to 5 mm depending on the specific needs such as about 0.1 mm, 0.5 mm, 1 mm, 1.5 mm, 2 mm, 2.5 mm, 3 mm, 3.5 mm, 4 mm, 4.5 mm and 5 mm. Nevertheless, thickness outside this range are also within the scope of the invention.

Typically, the liner (2) is manufactured by bending a sheet of material, e.g. a metal sheet, by a machine or otherwise so as to acquire an inverted “V” geometry, or concave shape, with the desired angular opening. The angular opening of the liner (2) that defines the hollow cavity is selected according to the effect which is sought. Typically, concave shape liners (2), more particularly V-shaped, show an angle of 60° to 120°, more particularly 75° to 105° or 85° to 95° and even more particularly about 90°.

The shock wave amplification element (5) can be configured to have dimensions and geometry that ensure a stable detonation of the total cutting charge, for which the axis of the shock wave amplification element (5) is preferably placed on the upper part of the center of the charge and parallel to its plane of symmetry. Furthermore, the shock wave amplification element (5) has a hole (5.1) to house the external initiation means (6).

The shock wave amplification element (5) can be for instance a cylinder, a parallelepiped or a truncated cone or any other geometric body, preferably with a width at its base equal to that of the top side of the explosive charge (3). To guarantee the minimum curvature of the shock wave amplification element (5) front when reaching the explosive charge (3) and its simultaneous initiation, the height of the shock wave amplification element (5) is preferably greater than or equal to the width. In the particular embodiment shown in FIG. 2, the shock wave amplification element (5) has a cylinder shape and its height is greater that its width.

In the whole set of Figures of the present application, the external initiation means (6) is a detonator. Other initiation systems are widely known to the skilled person. In a particular embodiment, the external initiation means (6) is selected from the group consisting of a detonator, booster or detonating cord. In particular embodiments, the external initiation means (6) is a detonator with booster.

In other particular embodiments, the linear cutting charge (10) of the invention is initiated without booster and with one detonator.

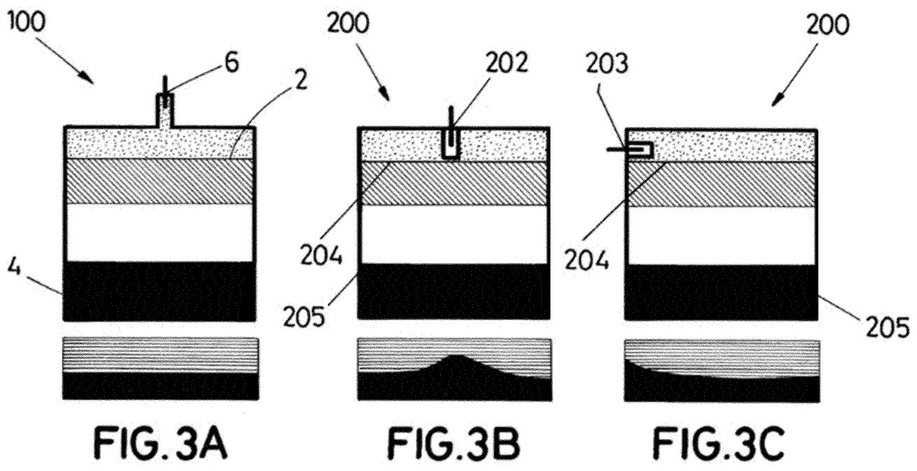

The ideal external initiation means position (6) will normally be on top of the explosive charge (3) and in the longitudinal center thereof. Other positions along the length of the explosive charge (3) are also possible, but preferably away from the ends by at least a distance equivalent to the width or diameter of the shock wave amplification element (5). Embodiments related to the positioning of external initiation means (6) are shown in FIG. 3A-3C where FIG. 3A shows an embodiment of the invention and FIGS. 3B and 3C are embodiments which are not part of the invention.

The invention is directed to a method for cutting a target material (4) which comprises:
a) providing a linear cutting charge (10) according to any one of claims 1 to 13,
b) providing at least one external initiation means (6);
c) placing the linear cutting charge (10) on the target material (4);
d) placing the at least one external initiation means (6) in the hole (5.1) of the shock wave amplification element (5); and
e) detonating the at least one external initiation means (6).

In a particular embodiment, the target material is a metal, for instance steel.

FIG. 3A to 3C depict initiation embodiments, particularly FIGS. 3B and 3C are described in Ortel, Matthew (“A modified initiation . . . ”), previously mentioned in the present document. These FIGS. 3B and 3C are to be compared with the embodiment of the invention wherein the top line of each FIGS. 3A to 3C shows different embodiments of initiation means (201, 202, 203) and where the bottom line show representations of the respective effect of each initiation means (201, 202, 203) embodiments on a target material (4, 205) to be cut. In the bottom line, the grey area represents the cut area and the black area represents the uncut area.

FIG. 3A shows an embodiment of a linear cutting charge (100) of the invention having a central integrated initiation means which is an embodiment of the external initiation means (6) of the invention. The cut area and the uncut area appears to be linear along the whole target material (4). The homogeneity of the cut area represented in FIG. 3A is due to the shock wave amplification element and the explosive charge being of the same material. Therefore, the present invention avoids interfaces and discontinuities. Also, the distance between the external initiation means (6) and the liner (2), also called run distance provided by the additional distance added by the shock wave amplification element on top of the explosive charge, allows the linear cutting charge (100) of the invention to provide a stable regime of detonation before the explosive charge is reached previous to hitting the liner (2).

FIG. 3B corresponds to an embodiment, not part of the present invention, having external initiation means (202) (such as RDX minibooster associated to pressed pentolite) inserted in the explosive charge of the linear cutting charge (200). The result shows a non-homogeneous initiation since the cut produced in the central area of the target material (205) is less than the resulting cut at the ends of the target material (205) due to the proximity of the external initiation means (202) to the liner (204). That is to say, the optimal detonation of the linear cutting charge (200) would be achieved to advance along the linear cutting charge (200) and increase the performance. In that particular embodiment, the linear cutting charge (200) is made of explosive charge only.

FIG. 3C shows an embodiment of a linear cutting charge (200), not part of the invention, having initiation means (203) introduced on a lateral of the explosive charge the linear cutting charge (200), also producing a non-homogeneous initiation as shown in the representation below the representation of the linear cutting charge (200) also due to the proximity of the external initiation means (202) to the liner (204). In both cases, FIGS. 3B and 3C, the initiation occurs in an area close to the liner (204), which does not allow the explosive to reach a steady-state, e.g optimal, detonation and, therefore, the depth of the cut is not constant as it is shown in results of FIG. 3A where the initiating means (201) are located away from the liner (204). In that particular embodiment, the linear cutting charge (200) is made of explosive charge only.

Experiments were conducted to study the performance of the LCC according to the teachings of the present invention. The results of several of these experiments are set forth below. Thus, the following examples illustrate the invention and must not be considered as limiting the scope thereof.

### EXAMPLES

### Example 1

In a reactor provided with a heating jacket and mechanical stirring, 1200 g of TNT were added and heated at 90° C. until melted; then, 1800 g of PETN were added, obtaining a composition as indicated in Table 2.

TABLE 2
Percentage composition of the explosive charge

| | % | g |
|---|---|---|
| PETN | 60 | 1800 |
| TNT | 40 | 1200 |
| Total | 100 | 3000 |

The components were stirred until a homogeneous mixture was obtained, and it was poured into a shell made of polyethylene foam (external dimensions 100 mm wide, 100 mm high and 200 mm long). The shell provided with a 2 mm thick copper liner and a cylinder to form the detonator housing, was filled through the upper cylindrical hole (20 mm diameter). Finally, once the explosive charge solidified, the cylinder for housing the detonator was extracted. The total weight of explosive charge was 560 g.

The LCC was tested on a 70 mm thick, 200 mm long and 200 mm wide S355JR steel plate. The initiation was carried out with a standard No. 8 blasting cap. The cutting of the steel plate showed a homogeneously pattern with a depth of 55 mm over the entire length of the plate as shown in scheme A of FIG. 3.

### Example 2

A mixture with a composition similar to that described in Table 1 and following the same procedure as in example 1 was poured into a shell, made of polyethylene foam, with external dimensions 160 mm wide, 180 mm high and 200 mm long, and provided with a 3 mm thick copper liner. The total weight of explosive was 1400 g. The cutting charge was tested on a 120 mm thick, 200 mm long and 200 mm wide S355JR steel plate. The initiation was carried out with a standard No. 8 blasting cap and the cutting of the steel sheet showed an homogeneously pattern with a depth a of 100 mm over the entire length of the plate as shown in scheme A of FIG. 3.

1. Linear cutting charge for cutting a target material, wherein the linear cutting charge comprises:
a liner having a concave inverted V shape, wherein the liner comprises an inner surface and an outer surface, and wherein the outer surface conforms a hollow cavity,
an explosive charge, having a longitudinal axis X-X′, located on top of the inner surface of the liner,
a shock wave amplification element located on top of the explosive charge and comprising a hole configured for housing an external initiation means; and
a shell having a cavity, wherein the shell is configured for housing the liner, the explosive charge and the shock wave amplification element;
wherein
the shock wave amplification element has the shape of a cylinder, having a width and a height, the height being greater than or equal to the width,
the shock wave amplification element and the explosive charge are made of the same explosive material and are integrated in the linear cutting charge as one unique element which shows no separation or discontinuity between them.

2. The linear cutting charge according to claim 1, wherein the shell comprises a low thermal conductivity material, preferably a material having a thermal conductivity below 10 W/m K.

3. The linear cutting charge according to claim 1, wherein the shell comprises a low density material, preferably a material having a density below or equal to 1.1 g/cm³.

4. The linear cutting charge according to claim 1, wherein the shell comprises a plastic or rubber material, preferably selected from the following list: ethylene vinyl acetate, nitrile rubber, silicone rubber, polychloroprene, polyvinyl chloride, polyimide, polyethylene, polypropylene, polystyrene or polyurethane or any combination thereof.

5. The linear cutting charge according to claim 1, wherein the shell comprises a top side and a bottom side and wherein the bottom side of the shell provides a stand-off distance dₛ between the liner and the bottom side of the shell.

6. The linear cutting charge according to claim 1, wherein the liner is made of a metal, preferably selected from the following list: copper, iron, steel, aluminum, nickel, molybdenum, tantalum, uranium or tungsten or any combination thereof.

7. The linear cutting charge according to claim 1, wherein the explosive of the shock wave amplification element and the explosive charge is a melted-cast explosive or a cast-cured explosive.

8. The linear cutting charge according to claim 7, wherein the melted-cast explosive comprises TNT or dinitroanisole.

9. The linear cutting charge according to claim 8 wherein the melted-cast explosive is selected from TNT or dinitroanisole and their mixtures with PETN, RDX or HMX.

10. The linear cutting charge according to claim Z, wherein the explosive material of the shock wave amplification element and the explosive material of the explosive charge is a cast-cured explosive selected from a plastic bonded explosive.

11. The linear cutting charge according to claim 10, wherein the explosive material of the plastic bonded explosive is made of a mixture of PETN, RDX or HMX with a binder and a cross-linking agent.

12. The linear cutting charge according to claim 1, wherein the explosive charge covers the inner surface of the liner completely.

13. The linear cutting charge according to claim 1, wherein the shock wave amplification element is placed on the longitudinal axis X-X′ of the explosive charge.

14. A linear cutting charge system for cutting a target material comprising:
a linear cutting charge according to claim 1, and
at least one external initiation means.

15. Method for cutting a target material which comprises:
a) providing a linear cutting charge according to claim 1,
b) providing at least one external initiation means;
c) placing the linear cutting charge on the target material;
d) placing the at least one external initiation means in the hole of the shock wave amplification element; and
e) detonating the at least one external initiation means.
